(19) United States
(12) Patent Application Publication
(10) Pub. No.: US 2025/0385361 A1
(43) Pub. Date: Dec. 18, 2025

(54) BATTERY STORAGE DEVICE

(71) Applicants: Korey Charles Odgers, Calgary (CA); Wayne Odgers, Calgary (CA)

(72) Inventors: Korey Charles Odgers, Calgary (CA); Wayne Odgers, Calgary (CA)

(21) Appl. No.: 18/746,485

(22) Filed: Jun. 18, 2024

(51) Int. Cl. H01M 50/231; H01M 50/236; H01M 50/238

(52) U.S. Cl. CPC H01M 50/231; H01M 50/236; H01M 50/238

(57) ABSTRACT

A battery storage device that is configured to receive and store batteries in order to inhibit damage to a surrounding environment in the event of a battery failure. The present invention is provided in both a rigid and collapsible environment wherein the difference is the construction of the outer layer of the wall. A rigid embodiment employs plastic or metal wherein the collapsible embodiment employs an outer layer of nylon or similar material. Both embodiments include a wall having a first layer and a second layer wherein the first layer is manufactured from a fire-resistant material and is adjacent the interior volume of the battery storage device. The second layer of the wall is manufactured from a chemically resistant material. A void is present on both sides of the second layer of the wall. Spacing members are present within the void.

### FIELD OF THE INVENTION

The present invention relates generally to battery storage, more specifically but not by way of limitation, a battery storage device configured to receive and retain batteries such as but not limited to lithium ion batteries wherein the device is configured to have multiple layers of in the wall thereof that are chemical resistant and fire retardant in the event of a battery failure so as to prevent damage to the immediate environment around the present invention.

### BACKGROUND

When a lithium-ion battery fire breaks out, the damage can be extensive. These fires are not only intense, they are also long-lasting and potentially toxic. Lithium-ion batteries are found in numerous consumer products. The occurrences of battery fires are becoming more common for a number of reasons. One reason, lithium-ion batteries are now in numerous consumer tech products, powering laptops, cameras, smartphones and more. The design of lithium ion batteries allows manufacturers of battery powered product to gain hours of battery life into increasingly small devices. While lithium-ion batteries are generally safe and unlikely to fail, many do fail and the number of failures are dramatically increasing. Noteworthy failures in recent years include Samsung issuing a global recall of one of their popular cellular phone models wherein the cited cause for the recall was battery cell issues. The issues would cause the phone to catch fire and explode. Other manufacturers such as but not limited to HP and Sony recalled devices such as but not limited to computers and hoverboards due to risk of catching fire and exploding.

Federal Agencies such as the Federal Aviation Administration have now banned uninstalled lithium-ion metal batteries from being checked in luggage and said they must remain with a passenger in their carry-on baggage, if approved by the airline and within the wattage specifications. All lithium-ion batteries use flammable materials, and incidents are typically the result of thermal runaway, which is a chain reaction that can lead to a fire or catastrophic explosion. Thermal runaway occurs when, for one reason or another, something causes a spark inside the lithium-ion battery's casing, leading to a chain reaction that eventually causes that casing to explode. That explosion can start a fire on its own, but in the worst-case scenario, if the battery is near flammable materials like cloth or oil, the fire can spread very quickly. The main cause contributing to the incidents is that the battery's casing is airtight and thus retains electro-conductive gasses and chemicals. If the casing is compromised through physical damage or overheated from improper charging, the gasses are vaporized, and the case expands. When the case reaches a critical point, it ruptures, releasing flammable fumes that can ignite violently. If the battery in question was in a smartphone, for instance, the phone would most likely explode.

Accordingly, there is a need for a battery storage device that is configured to receive and store therein a plurality of batteries when not in use wherein the device of the present invention is configured to inhibit fire and chemical damage to the surrounding environment in the event of a battery failure.

### SUMMARY OF THE INVENTION

It is the object of the present invention to provide a battery storage device that is configured to receive and store a plurality of batteries therein so as to prevent damage to the surrounding environment in the event of battery failure wherein the present invention includes a storage compartment.

Another object of the present invention is to provide a device configured to provide safe storage of batteries when not in use wherein the storage compartment of the present invention includes a hard case embodiment and a soft case embodiment.

A further object of the present invention is to provide a battery storage device that is configured to receive and store a plurality of batteries therein so as to prevent damage to the surrounding environment in the event of battery failure wherein both embodiments of the present invention have a similar wall construction.

Yet a further object of the present invention is to provide a device configured to provide safe storage of batteries when not in use wherein the walls of the storage compartment include a first layer that is manufactured from fire retardant material.

Still another object of the present invention is to provide a battery storage device that is configured to receive and store a plurality of batteries therein so as to prevent damage to the surrounding environment in the event of battery failure wherein the walls of the storage compartment include a second layer that is manufactured from a chemical resistant material.

An additional object of the present invention is to provide a device configured to provide safe storage of batteries when not in use wherein the walls include a third outer layer being provided in a rigid or collapsible embodiment.

Yet a further object of the present invention is to provide a battery storage device that is configured to receive and store a plurality of batteries therein so as to prevent damage to the surrounding environment in the event of battery failure wherein a void is present intermediate all three layers of the wall of the storage compartment.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of a rigid embodiment of the present invention; and

FIG. 2 is a perspective view of a collapsible embodiment of the present invention; and

FIG. 3 is a cross-section diagrammatic view of the wall of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a battery storage device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

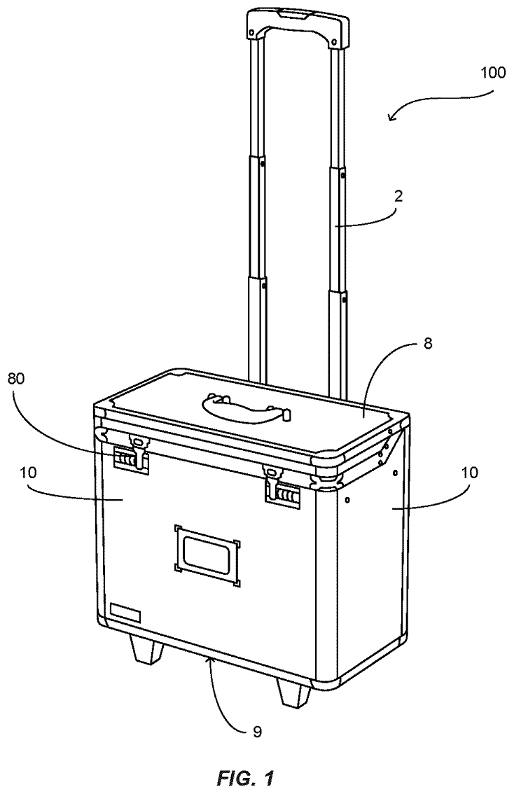

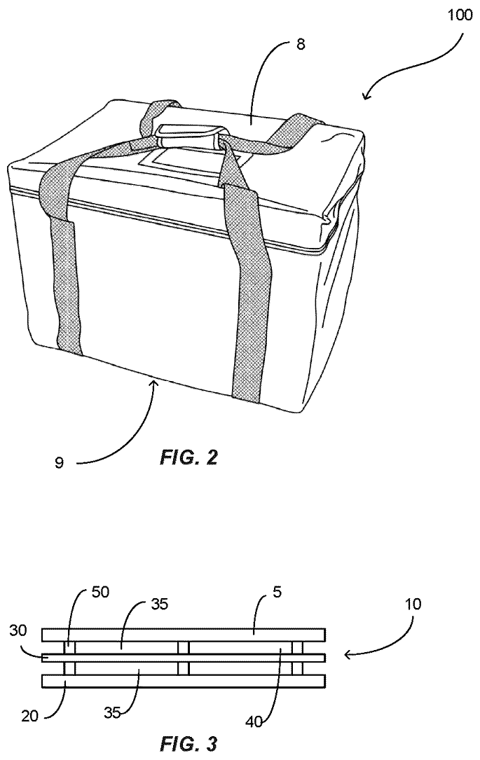

Referring in particular to the Figures submitted herewith, the battery storage device 100 is provided in two embodiments, illustrated herein is FIG. 1 and FIG. 2 submitted herewith. A first embodiment, illustrated in FIG. 1 is a rigid embodiment wherein the walls 10 have an outer layer 5 manufactured from a rigid material such as but not limited to plastic or metal. A second embodiment, illustrated herein in FIG. 2, the outer layer 5 is manufactured from a collapsible material such as but not limited to nylon. As is further discussed herein, the construction of the wall 10 is identical across both embodiments with the exception of the outer layer 5. It should further be understood within the scope of the present invention that the battery storage device 100, for both embodiments, could be provided in alternate sizes wherein a size could be manufactured to store and receive a small computing device and/or battery thereof or the battery storage device 100 could be sized to receive and retain a multitude of batteries. Additionally, the embodiment illustrated herein in FIG. 1 is further provided with wheels and a retractable handle 2 so as to facilitate the transportation thereof. It should further be understood that the top member 8 and bottom member 9 of both embodiments are identically constructed as the wall 10 of that embodiment. The embodiment in FIG. 1 further includes locking members 80 so as to control access to the interior volume thereof.

The wall 10 includes a first layer 20 wherein the first layer 20 is configured to be chemically resistant. The first layer 20 is fire resistant as the first layer is adjacent to the interior volume of the battery storage device 100 and in the event of a battery failure, the fire resistant first layer 20 inhibits flames from comprising the first layer 20. It is contemplated within the scope of the present invention that the first layer 20 could be manufactured from fire resistant materials such as but not limited to aramid or modacrylic. It is contemplated within the scope of the present invention that the first layer 20 could be provided in alternate thicknesses.

The wall 10 includes a second layer 30 wherein the second layer 30 is configured to be chemically resistant. The second layer 30 is chemical resistant in order to inhibit chemicals from contacting the outer layer 5 and in the event of a battery failure, the chemical resistant second layer 30 inhibits chemicals from comprising the second layer 30 and as such the outer wall. It is contemplated within the scope of the present invention that the second layer 30 could be manufactured from chemically resistant materials such as but not limited to polyvinylidene fluoride or polyethylene terephthlate. It is further contemplated within the scope of the present invention that the second layer 30 could be provided in alternate thicknesses.

A void 35 is present on both sides of the second layer 30. The void 35 provides additional insulation and further provides a location for spacing members 50. The spacing members 50 provide separation of the first layer 20, second layer 30 and outer layer 5 and are dispersed along wall 10 being less than the full height thereof so as to allow the collapsible embodiment to collapse. The spacing members 50 are manufactured of a combination of fire and chemical resistant materials and are laterally dispersed along the length of the wall of a suitable distance such as but not limited to every two inches. It is contemplated within the scope of the present invention that the battery storage device 100 could employ alternate quantities of spacing members 50 in the wall 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A battery storage device configured to receive and store batteries and prevent damage to the surrounding environment wherein the battery storage device comprises:
a storage compartment, said storage compartment having a plurality of walls, bottom and a top integrally formed to create an interior volume, said walls, bottom and top having a first layer, a second layer and an outer layer, said second layer being intermediate said first layer and said outer layer, said walls, bottom and top having a first void between said first layer and said second layer, said walls, bottom and top having a second void between said second layer and said outer layer, said first void having a plurality of spacing members mounted therein so as to maintain a gap between said second layer and said first layer, said second void having a plurality of spacing member mounted therein so as to maintain a gap between said second layer and said outer layer of said wall; and
wherein said first layer of said wall is manufactured from a fire resistant material and said second layer of said wall is manufactured from a chemically resistant material.

2. The battery storage device configured to receive and store batteries and prevent damage to the surrounding environment as recited in claim 1, wherein the battery storage device is provided in a rigid embodiment, wherein in the rigid embodiment the outer layer is manufactured from a rigid material.

3. The battery storage device configured to receive and store batteries and prevent damage to the surrounding environment as recited in claim 2, wherein the rigid embodiment includes locking members operably coupled to the top.

4. The battery storage device configured to receive and store batteries and prevent damage to the surrounding environment as recited in claim 3, wherein the battery storage device is provided in a collapsible embodiment, wherein in the collapsible embodiment the outer layer is manufactured from a collapsible material.

5. The battery storage device configured to receive and store batteries and prevent damage to the surrounding environment as recited in claim 4, wherein the spacing members are manufactured of a height that is less than a height of the wall.
